(19) United States
(12) Patent Application Publication
(10) Pub. No.: US 2024/0423170 A1
(43) Pub. Date: Dec. 26, 2024

(54) NESTING BLOCK FOR INSECTS

(71) Applicant: Tyler Torrie, Grassy Lake (CA)

(72) Inventor: Tyler Torrie, Grassy Lake (CA)

(21) Appl. No.: 18/749,590

(22) Filed: Jun. 20, 2024

Related U.S. Application Data
(60) Provisional application No. 63/522,135, filed on Jun. 20, 2023.

(51) Int. Cl. A01K 47/02

(52) U.S. Cl. CPC A01K 47/02

(57) ABSTRACT

A nesting block has a stack of panels. Adjacent panels in the stack of panels comprise a top panel and a bottom panel. Adjacent panels have a plurality of channels defined by the bottom surface of the top panel and the top surface of the bottom panel, each channel having an open end at the front edge of panels and a closed end toward the back edge of the panels. A hinge connection connects the back edges of the top panel and the bottom panel. A coupling releasably couples the top panel and the bottom panel. There is a sealing engagement between the bottom surface of the top panel and the top surface of the bottom panel and along the back edge and the opposed side edges when the top panel is coupled to the bottom panel.

### TECHNICAL FIELD

This relates to nesting blocks for insects, and in particular, nesting blocks with separable layers.

### BACKGROUND

Nesting blocks are commonly made from expanded polystyrene or wood and have an array of holes in which certain types of bees or other insects lay their eggs. Nesting blocks may be used to gather the eggs so that they may be reused in subsequent seasons. In one example, nesting blocks may be provided when leafcutter bees are used to pollenate fields. Leafcutter bees and shelters may be distributed throughout a field early in the growing season along with nesting blocks where the leafcutter bees lay eggs. The nesting blocks are then gathered and the eggs extracted from the nesting block. The eggs may then be developed into bees that are distributed the next growing season.

U.S. Pat. No. 7,086,924 (Mills) entitled “Modular cavity nesting for hymenoptera” describes a modular nesting block with multiple leaves connected to a spine with grooves in each leaf that cooperate with adjacent grooves to form nesting cavities.

### SUMMARY

According to an aspect, there is provided a nesting block. The nesting block has a stack of panels. Each panel has a top surface, a bottom surface, a front edge, a back edge, and opposed side edges that extend between the front edge and the back edge. Adjacent panels in the stack of panels comprise a top panel and a bottom panel. The adjacent panels comprise a plurality of channels defined by the bottom surface of the top panel and the top surface of the bottom panel, each channel having an open end at the front edge of the top and bottom panels and a closed end toward the back edge of the top panel and the bottom panel. A hinge connection connects the back edges of the top panel and the bottom panel. A coupling releasably couples the top panel and the bottom panel, the coupling comprising a first coupling part carried by the top panel and a second coupling part carried by the bottom panel. A sealing engagement seals between the bottom surface of the top panel and the top surface of the bottom panel, the scaling engagement sealing along the back edge and the opposed side edges when the top panel is coupled to the bottom panel.

According to other aspects, the nesting block may include one or more of the following features, alone or in combination: the channels may have a circular cross-section; there may be grooves in the opposed side edges for mounting in a nesting block holder; the sealing engagement may comprise a tongue and groove engagement; the sealing engagement may comprise the coupling; the hinge connection may comprise a first hinge part and a second hinge part, wherein the first hinge part comprises a shaft or a resilient receiver configured to receive the shaft and the second hinge part comprises the other of the shaft and the resilient receiver; each panel may further comprise an alignment engagement, the alignment engagement comprising alignment pins in the top surface or the bottom surface; the coupling may be a resilient clip and a clip receiver, the release comprising an aperture that permits access to the resilient clip, wherein pressure applied to the resilient clip via the aperture causes the resilient clip to disengage from the receiver; the stack of panels may comprise a capping panel, a base panel, and a plurality of intermediate panels; the number of intermediate panels may be adjustable; the plurality of channels may be defined by partial channels formed in the bottom surface and the top surface of each panel, wherein the partial channels in the bottom surface are laterally offset from the partial channels in the top surface.

According to an aspect, there is provided a method of managing a lifecycle of bees, the method comprising the steps of:
forming a nesting block by stacking panels, each panel having a top surface, a bottom surface, a front edge, a back edge, and opposed side edges that extend between the front edge and the back edge, wherein adjacent panels in the stack of panels comprise a top panel and a bottom panel, the adjacent panels comprising a plurality of channels defined by the bottom surface of the top panel and the top surface of the bottom panel, each channel having an open end at the front edge of the top and bottom panels and a closed end toward the back edge of the top and bottom panel; connecting adjacent panels by a hinge connection that connects the back edges of the top panel and the bottom panel; and forming a sealing engagement between the bottom surface of the top panel and the top surface of the bottom panel by releasably coupling the top and bottom surfaces of adjacent panels, wherein the sealing engagement seals along the back edge and the opposed side edges when the top panel is coupled to the bottom panel;
allowing bees to lay eggs within the channels;
releasing the top panel from the bottom panel;
while connected by the hinge connection, pivoting the top panel relative to the bottom panel to expose the channels; and
harvesting the eggs from the nesting block.

According to other aspects, the method may include one or more of the following features, alone or in combination: the channels may have a circular cross-section; the method may further comprise the step of placing the nesting block in a nesting block holder; the method may comprise the step of forming a sealing engagement comprises engaging a tongue and groove engagement; the hinge connection may comprise a shaft and a resilient receiver configured to receive the shaft, and the step of connecting adjacent panels by a hinge connection may comprise applying pressure to the shaft and the resilient receiver such that the shaft is received by the resilient receiver; the method may comprise the step of aligning adjacent panels with an alignment pin on the panels; the coupling may be a resilient clip and a clip receiver, and the step of coupling adjacent panels may comprises coupling the resilient clip to the clip receiver; the step of stacking panels may comprise stacking a plurality of intermediate panels on a base panel and staking a capping panel on the plurality of intermediate panels; the number of intermediate panels may be adjustable.

In other aspects, the features described above may be combined together in any reasonable combination as will be recognized by those skilled in the art.

### BRIEF DESCRIPTION OF THE DRAWINGS

These and other features will become more apparent from the following description in which reference is made to the appended drawings, the drawings are for the purposes of illustration only and are not intended to be in any way limiting, wherein:

FIG. 1 is a bottom, front perspective view of a stack of panels for a nesting block.

FIG. 2 is a top, front perspective view of a stack of panels for a nesting block.

FIG. 3 is a top, rear perspective view of a stack of panels for a nesting block.

FIG. 4 is a rear elevation view of a stack of panels for a nesting block.

FIG. 5 is a front elevation view of a stack of panels for a nesting block.

FIG. 6 is a side elevation view of a stack of panels for a nesting block.

FIG. 7 is a bottom, rear perspective view of a stack of panels for a nesting block.

FIG. 8 is a bottom plan view of a stack of panels for a nesting block.

FIG. 9 is a top plan view of a stack of panels for a nesting block.

FIG. 10 is a top, front perspective view of a stack of panels for a nesting block.

FIG. 11 is a top plan view of a stack of panels for a nesting block.

FIG. 12 is a top, front perspective view of the front edge of a stack of panels for a nesting block.

FIG. 13 is a top, front perspective view of the side edge of a stack of panels for a nesting block.

FIG. 14 is a top, front perspective view of the back edge of a stack of panels for a nesting block.

FIG. 15 is an elevated front view of a nesting block.

### DETAILED DESCRIPTION OF PREFERRED EMBODIMENTS

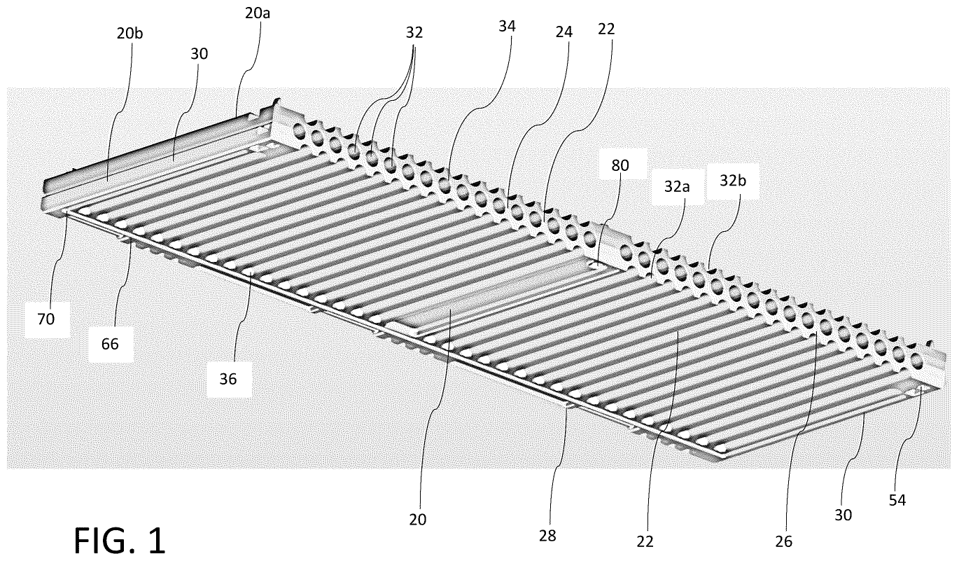

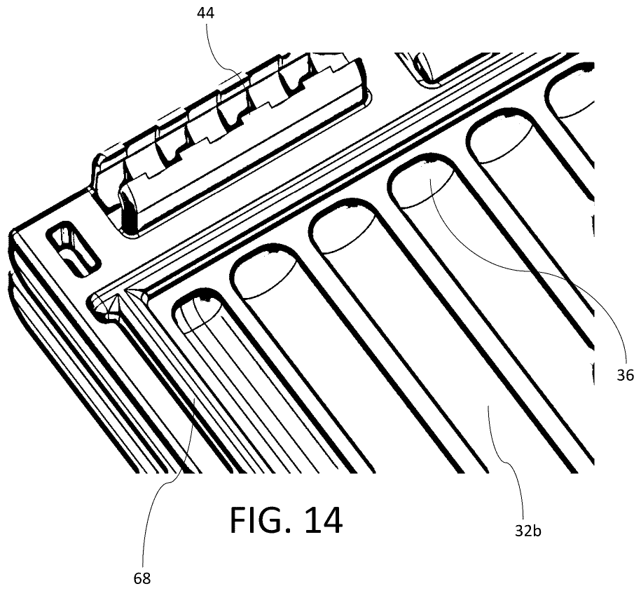

A nesting block, generally identified by reference number 10, will now be described with reference to FIG. 1 through 15. Nesting block 10 as depicted is designed to provide nesting space for leafcutter bees. However, nesting block 10 may be used for other species of bees or insects. Nesting block 10 may be used in areas with plants that require pollination, such as in agricultural fields, for bee farming, or other purposes.

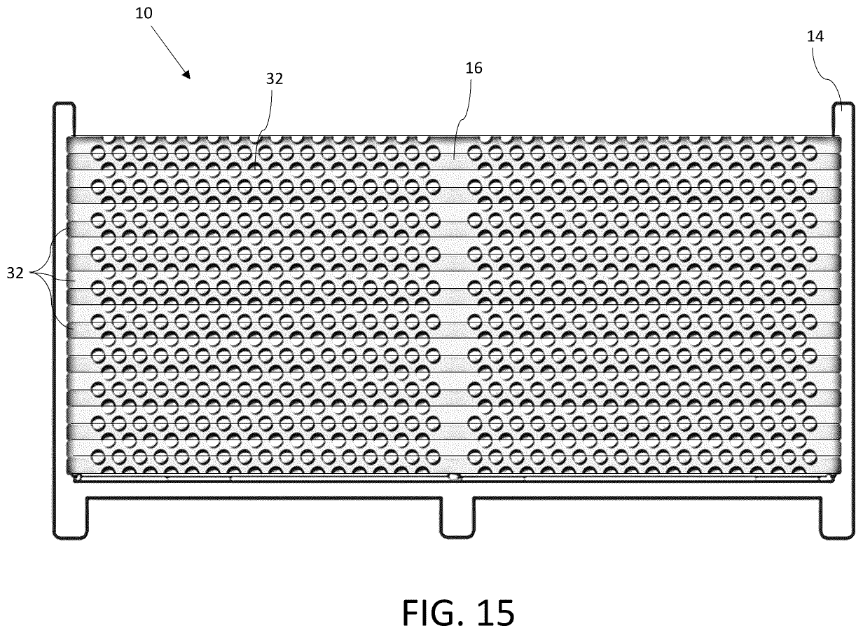

Referring to FIG. 15, nesting block 10 has a stack 16 of panels 20. While a significant number of panels 20 is shown in stack 16 in FIG. 15, panels 20 are designed to be modular and stack 16 may include any appropriate number of panels 20. Referring to FIG. 1, each panel 20 has a top surface 22, a bottom surface 24, a front edge 26, a back edge 28, and opposed side edges 30 that extend between front edge 26 and back edge 28. The depicted design provides panels 20 in pairs, with a top panel 20a and a bottom panel 20b. As used herein, the use of the terms “top” or “bottom” is for convenience in discussing the relational aspects and relative position of adjacent elements of nesting block 10 and panels 20, rather than a description of absolute position of the elements. Depending on the orientation of the stack and the number of panels 20, top panel 20a, with an adjacent panel bottom panel 20b, could also be referred to as a bottom panel 20b, or the reverse. In addition, the use of top and bottom does not require that the “top” be positioned above the “bottom” relative to a ground surface on which nesting block 10 is placed as the stack may be inverted, or set on its edge, in which case panels 20a and 20b could be referred to as side panels. Where panels 20 are provided with a particular engagement profile, one orientation may be preferred over another to avoid potential damage to the profiles, for convenience of use, or depending on the support structure on which stack 16 of panels 20 is used.

The panels 20 in a given stack may be the same, or there may be intermediate panels that have semi-circular grooves and engagement profiles on both faces, while the capping panels, i.e., those panels on the top and bottom ends of the stack, only have semi-circular grooves and engagement profiles on a top or bottom face. It is not necessary to have different end panels, and it may be convenient to stack panels 20 that have grooves on top and bottom surfaces. As such, the description below will be limited to what may be termed “intermediate” panels that have grooves on a top face 22 (referring to FIG. 9) and a bottom face 24 (referring to FIG. 8), with the understanding that capping panels may be used if desired (not shown).

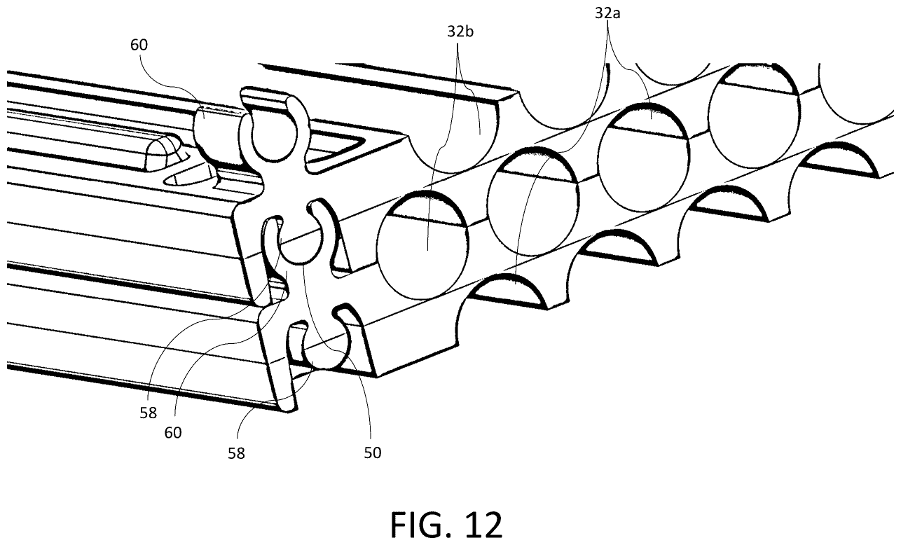

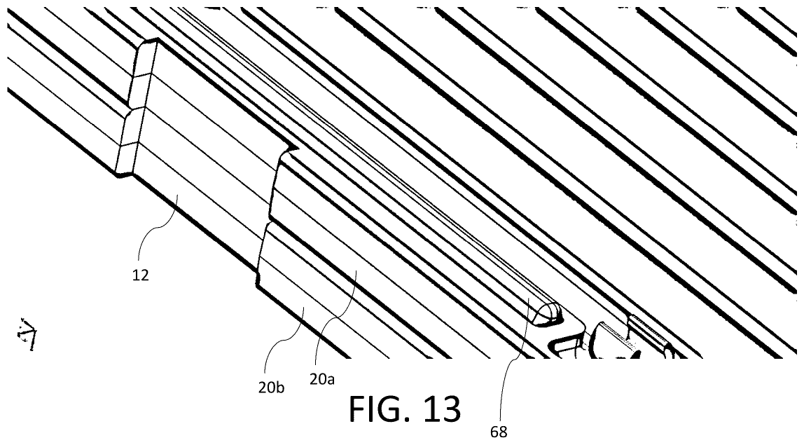

When top panel 20a and bottom panel 20b are stacked together, complementary grooves 32a and 32b may be formed in bottom surface 24 of top panel 20a and top surface 22 of bottom panel 20b, respectively, that cooperate to form channels 32. Each channel 32 has an open end 34 at front edge 26 of the adjacent panels 20 and a closed end 36 towards back edge 28 of the adjacent panels 20. Channels 32 may be shaped and sized to promote their use as a nesting hole. Referring to FIG. 5, channels 32 may have a circular cross section, which may be formed by complementary top channel portion 32a and bottom channel portion 32b formed in bottom surface 24 of top panel 20a and top surface 22 of bottom panel 20b, respectively. Circular channels 32 may have a diameter of up to 6.5 mm or more, and may have a depth of up to 5 inches or more. Referring to FIG. 5, top channel portion 32a and bottom channel portion 32b on the same panel 20 may be offset in the plane of panel 20 such that channels 32 are organized in an offset lattice, which may be used to increase the packing density of channels 32. Where offset channels 32 are used, the stack 16 of panels 20 will require a set of panels 20, such as panels 20a and 20b, to allow channels 32 to be properly aligned between adjacent panels. Referring to FIG. 12, channels 32 may be aligned such that a top of top channel portion 32a is level with a bottom of bottom channel portion 32b.

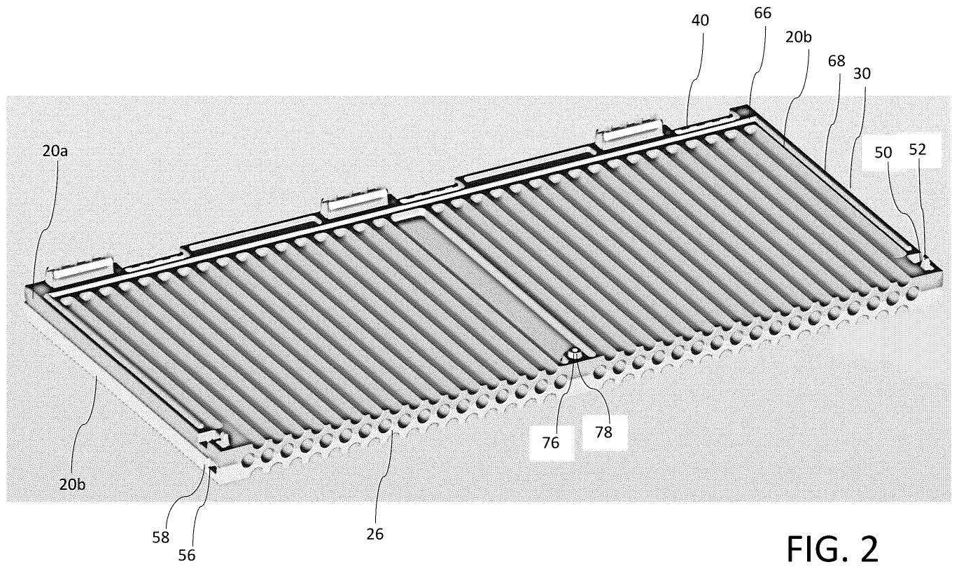

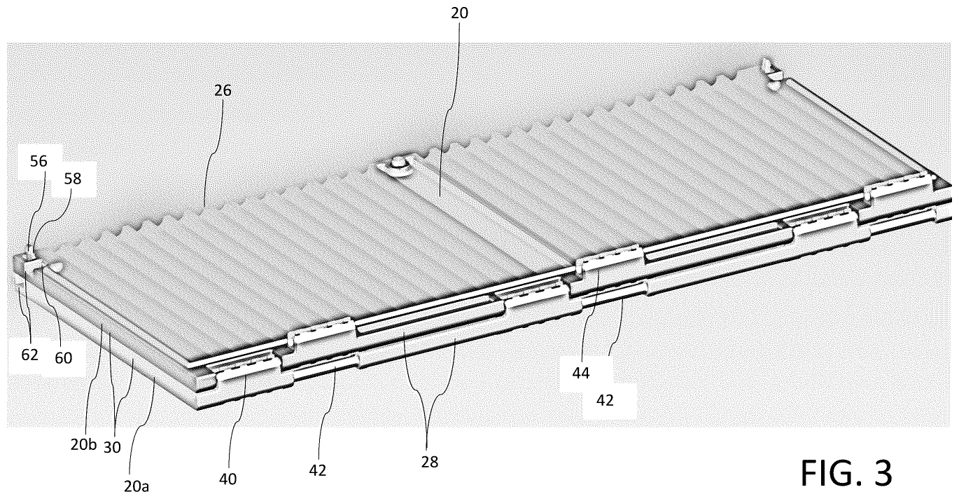

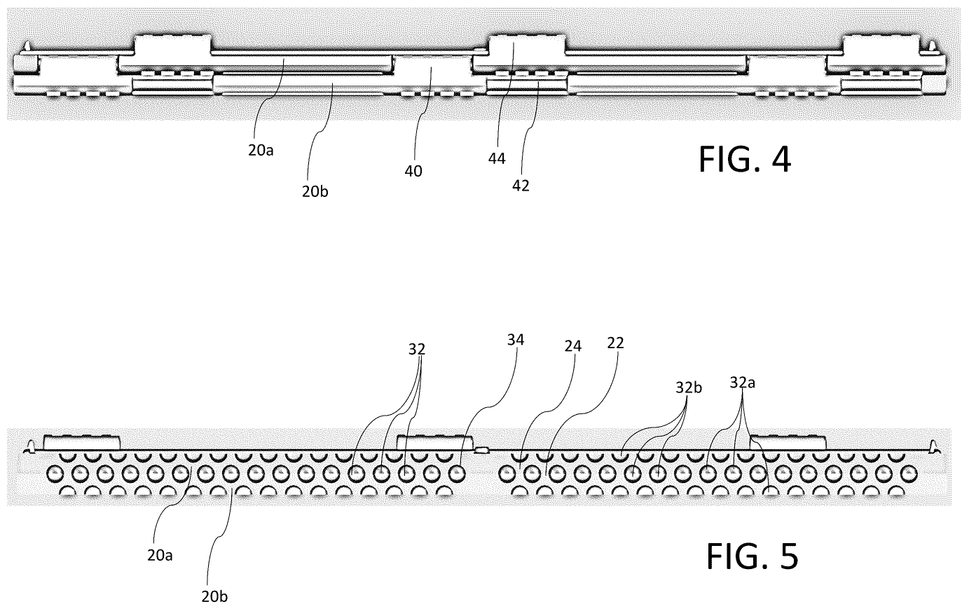

Referring to FIG. 2 and FIG. 3, each panel 20 has a hinge connection 40 that connects back edges 28 of top panel 20a and bottom panel 20b and allows adjacent panels to pivot relative to one another (not shown) around hinge connection 40. Hinge connections 40 may be designed such that adjacent panels 20 can be selectively connected and disconnected at hinge connection 40. Referring to FIG. 4, hinge connection 40 may include a shaft 42 and a resilient receiver 44 configured to receive shaft 42. In the depicted example, shaft 42 is accessible from bottom surface 24 of panel 20, and resilient receiver 44 extends above top surface 22 such that it engages shaft 42. As shown, top panel 20a and bottom panel 20b may be designed with alternating positions of shaft 42 and resilient receiver, in which case there may be two different designs used for intermediate panels 20. In the depicted example, panels 20 may be designed to work in pairs when designing a larger stack 16 of panels 20. This results in hinge connections 40 being staggered between adjacent panels 20. Shaft 42 may be positioned such that shaft 42 intersects with a central plane of panel 20, where the central plane extends through panel 20. When shaft 42 is received by resilient receiver 44, the central axis of shaft 42 defines the axis of rotation for adjacent panels 20 rotating around hinge connection 40. Panels 20 may also be designed such that receiver 44 is aligned with panel 20, and shaft 42 is above the plane of panel 20. Referring to FIG. 3, hinge connections 40 may be offset between adjacent panels 20a and 20b. This allows panels 20 to be designed thinner, providing a higher packing density. This is made possible by providing panels 20 in groups, such as groups of two, three, or more panels, rather than as individual panels.

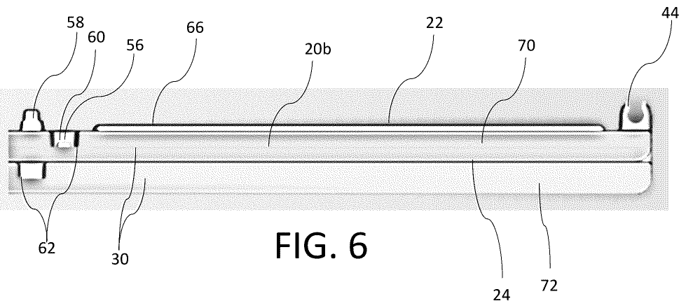

Adjacent panels 20a and 20b may be secured together using a coupling 50 toward front edge 26 of panels 20 relative to hinge connection 40. Coupling 50 may have a first coupling part 52 carried by top panel 20a and a second coupling part 54 carried by bottom panel 20b. Referring to FIG. 6, panel 20 may include a release 56 that selectively releases first coupling part 52 from second coupling part 54. Alternatively, coupling 50 may be released by applying sufficient pressure to separate panels 20a and 20b. Referring to FIG. 12, first coupling part 52 may be a resilient clip 58, and second coupling part 54 may be a clip receiver 60 that receives the resilient clip 58. Inserting resilient clip 58 fully into clip receiver 60 may cause coupling 50 to be engaged, and resilient clip 58 may require pressure to be applied to disengage resilient clip 58 from receiver 60. Referring to FIG. 3, receiver 60 may include an aperture 62 that permits access to resilient clip 58. As shown, coupling 50 may be located adjacent to each opposed side edge 30, with aperture 62 being in opposed side edges 30. Release 56 may be designed such that a purpose-built tool may be used. This may permit adjacent panels 20 to be separated using automated equipment.

Adjacent panels 20a and 20b may also be secured together using other designs. For example, rather than a clip, coupling 50 may be a friction fit part (not shown), where a male engagement is received within a female engagement with sufficient force to secure panels 20a and 20b together. There may be a profile that provides haptic feedback to confirm coupling 50 is fully engaged, and that resists unintentional disengagement.

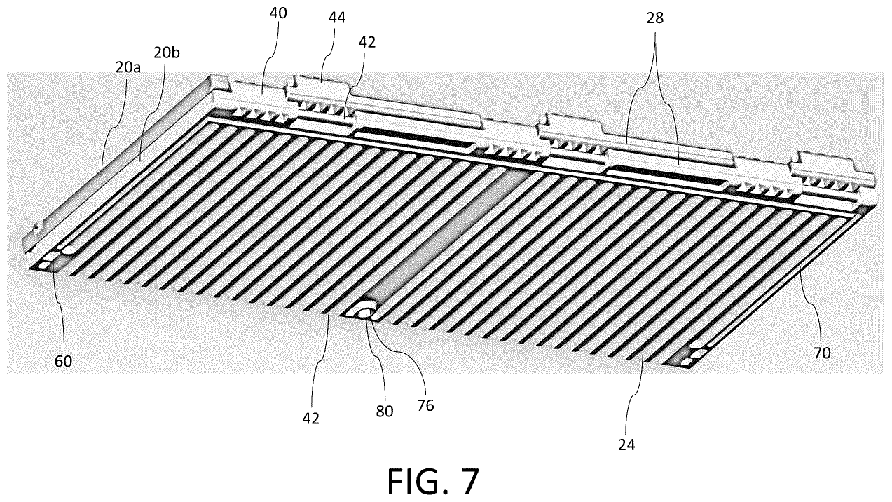

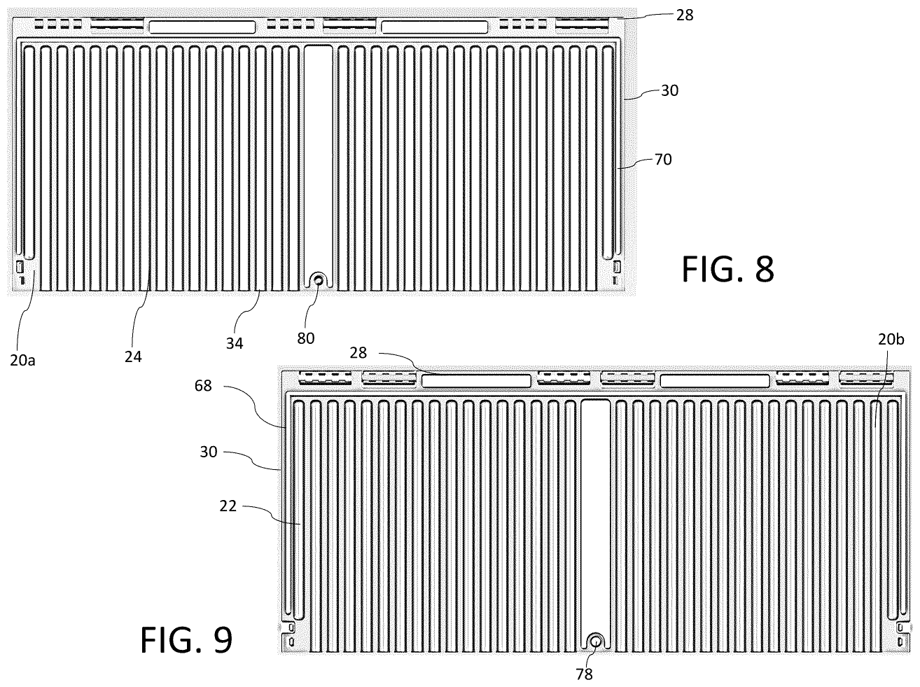

Referring to FIG. 7 to FIG. 9, a sealing engagement 66 is formed between bottom surface 24 of top panel 20a and top surface 22 of bottom panel 20b. Sealing engagement 66 seals along back edge 28 and opposed side edges 30 when top panel 20a is coupled to bottom panel 20b. Sealing engagement 66 may be sufficient to prevent parasites, or other harmful or unwanted organisms, from accessing channels 32 from the side or back of channels 32 in order to protect eggs in channels 32. Sealing engagement 66 may be a tongue and groove engagement as shown, with one of a tongue 68 or a groove 70 on bottom surface 24 of top panel 20a and the other of the tongue 68 or groove 70 on top surface 22 of bottom panel 20b, and may form a continuous seal around opposed side edges 30 and back edge 28. Each panel 20 may also include alignment engagements 76 that align top panel 20a with bottom panel 20b when engaged together. Alignment engagement 76 may include an alignment pin 78 on either bottom surface 24 or top surface 22 and an alignment pin receiver 80 on the other of bottom surface 24 or top surface 22. Scaling engagement 66 may also be part of coupling 50, with tongue 68 forming a friction fit with groove 70 to hold adjacent panels 20. If the friction fit provided by groove 70 is sufficient to secure panels 20a and 20b, it may be unnecessary to have a separate coupling as depicted above. In such a case, groove 70 may be designed with a profile that assists with locking and/or to provide haptic feedback that confirms engagement.

Referring to FIG. 6, stack 16 of panels 20 may include one or more intermediate panels 70 stacked above a base panel 72 and below a capping panel (not shown). Capping panel and base panel 72 may be designed with a flat top or bottom surface, respectively, as the stack does not extend above or below those panels. Similarly, capping panel or base panel 72 may be provided with one part of hinge connector 40, rather than both parts as with intermediate panels 70. Intermediate panels 70 may be a stack of alternating top panels 20a and bottom panels 20b as shown and described above. Depending on the design of grooves 32 and hinge connectors 40, intermediate panels 70 may also be a stack of identically formed panels, or may be intended to be used in groups with two, three or more complementary forms. Regardless of the number of forms that panels 20 may have, the number of intermediate panels may be adjustable such that the stack 16 of panels 20 in nesting block 10 is modular. In the depicted example, there are two types of panels 20, where increasing the number of panels 20 requires one of each, i.e. to be increased in pairs in the depicted embodiment.

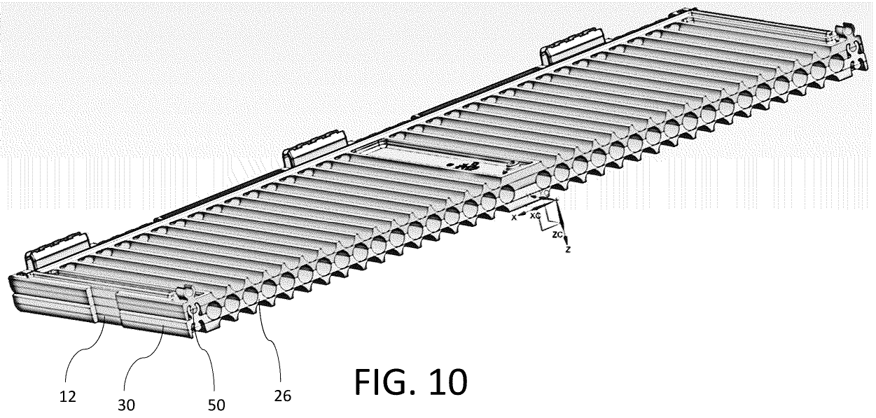

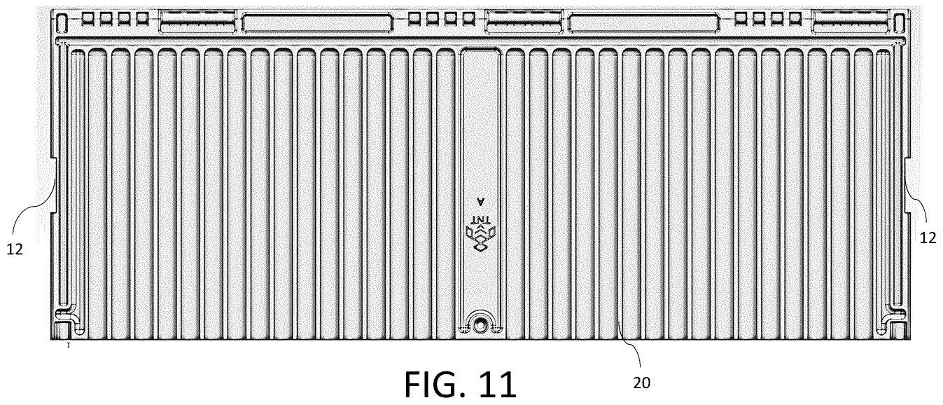

Panels 20 may have a mounting profile 12 in an external surface for mounting nesting block 10 in a nesting block holder 14, as shown in FIG. 14. Referring to FIG. 10 and FIG. 11, mounting profile 12 may be notches in opposed side edges 30 of panels 20 that are aligned when panels are engaged as a stack in adjacent panels 20. Nesting block holder 14 may be a rack that holds multiple nesting blocks 10 or a holder designed to support a single nesting block 10, as shown.

Nesting block 10 may used to manage a lifecycle of bees. Nesting block 10 is formed by stacking a plurality of panels 20 as described above, such as by stacking pairs of top and bottom panels 20a and 20b in an alternating manner. As shown, adjacent panels 20 are connected by hinge connection 40 that connects the back edges 28. Hinge connection 40 may be connected by applying pressure between shaft 42 and resilient receiver 44 such that shaft 42 is received by resilient receiver 44. Adjacent panels 20 are then able to pivot relative to each other about hinge connection 40. In the closed position, panels 20 are releasably coupled toward the front edge of panels 20 relative to hinge connection 40. When coupling 50 is engaged, a seal is formed between adjacent panels 20 along back edge 28 and opposed side edges 30. Panels 20 may be aligned when they are pivoted into position by an alignment engagement 76.

Nesting block 10 allows bees to nest and lay eggs within channels 32. Nesting block 10 may be placed in a nesting block holder 14 while the colony of bees build the nest and lay eggs so that it may be securely held against inclement weather, and protected from potentially harmful organisms. The eggs may be harvested from nesting block 10 by disengaging coupling 50 to release top panel 20a from bottom panel 20b and, while connected by hinge connection 40, top panel 20a is pivoted relative to bottom panel 20b to expose channels 32. Eggs within channels 32 may then be removed, such as by using a mechanical brush or scraper, or using an air nozzle to blow the eggs out. Preferably, panels 20 are made from, or coated with, a non-porous, low friction material such as plastic, which reduces the adhesion of the eggs to the inner walls of channels 32, making it easier to remove the eggs. The adhesion between eggs and channels 32 that must be overcome to remove eggs is also reduced by allowing panels 20 to separate. Each panel 20 in the stack is opened this way until nesting block 10 is empty of eggs. Couplings 50 of adjacent panels 20 may then be reengaged to reform nesting block 10 for reuse. Prior to reuse, panels 20 may be washed, such as with an antimicrobial cleaner to reduce the risk of disease when reused. An individual panel 20 or multiple panels 20 may be removed from nesting block 10 by disengaging coupling 50 and hinge connection 40 of the panel 20 above the panels 20 to be removed, then disengaging coupling 50 and hinge connection 40 from the panel 20 below the panels 20 to be removed, and reattaching the coupling 50 and hinge connection 40 of the above panel 20 to the below panel 20.

The material of panels 20 (or coating applied to the inner surface of channels 32) may be antimicrobial, either inherently or because of additives or coatings applied during manufacture, in which case panels 20 may be simply cleaned to remove debris, such as mechanically or with water. Panels 20 may be made from a single material or a composite, depending on the desired mechanical properties and the preferences of the user. For example, panels 20 may be formed from a wood-infused plastic to make nesting block 10 more attractive to bees or other insects that prefer nesting in wood. Panels 20 may be made using an injection mold or 3D printer.

In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context requires that there be one and only one of the elements.

The scope of the following claims should not be limited by the preferred embodiments set forth in the examples above and in the drawings, but should be given the broadest interpretation consistent with the description as a whole.

What is claimed is:

1. A nesting block, comprising:
a stack of panels, each panel having a top surface, a bottom surface, a front edge, a back edge, and opposed side edges that extend between the front edge and the back edge, wherein adjacent panels in the stack of panels comprise a top panel and a bottom panel, the adjacent panels comprising:
a plurality of channels defined by the bottom surface of the top panel and the top surface of the bottom panel, each channel having an open end at the front edge of the top and bottom panels and a closed end toward the back edge of the top panel and the bottom panel;
a hinge connection that connects the back edges of the top panel and the bottom panel; and
a coupling that releasably couples the top panel and the bottom panel, the coupling comprising a first coupling part carried by the top panel and a second coupling part carried by the bottom panel; and
a sealing engagement between the bottom surface of the top panel and the top surface of the bottom panel, the sealing engagement sealing along the back edge and the opposed side edges when the top panel is coupled to the bottom panel.

2. The nesting block of claim 1, wherein the channels have a circular cross-section.

3. The nesting block of claim 1, further comprising grooves in the opposed side edges for mounting in a nesting block holder.

4. The nesting block of claim 1, wherein the sealing engagement comprises a tongue and groove engagement.

5. The nesting block of claim 1, wherein the sealing engagement comprises the coupling.

6. The nesting block of claim 1, wherein the hinge connection comprises a first hinge part and a second hinge part, wherein the first hinge part comprises a shaft or a resilient receiver configured to receive the shaft and the second hinge part comprises the other of the shaft and the resilient receiver.

7. The nesting block of claim 1, wherein each panel further comprises an alignment engagement, the alignment engagement comprising alignment pins in the top surface or the bottom surface.

8. The nesting block of claim 1, wherein the coupling is a resilient clip and a clip receiver, the release comprising an aperture that permits access to the resilient clip, wherein pressure applied to the resilient clip via the aperture causes the resilient clip to disengage from the receiver.

9. The nesting block of claim 1, wherein the stack of panels comprises a capping panel, a base panel, and a plurality of intermediate panels.

10. The nesting block of claim 9, wherein the number of intermediate panels is adjustable.

11. The nesting block of claim 1, wherein the plurality of channels are defined by partial channels formed in the bottom surface and the top surface of each panel, and wherein the partial channels in the bottom surface are laterally offset from the partial channels in the top surface.

12. A method of managing a lifecycle of bees, the method comprising the steps of:
forming a nesting block by:
stacking panels, each panel having a top surface, a bottom surface, a front edge, a back edge, and opposed side edges that extend between the front edge and the back edge, wherein adjacent panels in the stack of panels comprise a top panel and a bottom panel, the adjacent panels comprising a plurality of channels defined by the bottom surface of the top panel and the top surface of the bottom panel, each channel having an open end at the front edge of the top and bottom panels and a closed end toward the back edge of the top and bottom panel;
connecting adjacent panels by a hinge connection that connects the back edges of the top panel and the bottom panel;
releasably coupling adjacent panels by engaging a first coupling part carried by the top panel and a second coupling part carried by the bottom panel; and
forming a sealing engagement between the bottom surface of the top panel and the top surface of the bottom panel, the sealing engagement sealing along the back edge and the opposed side edges when the top panel is coupled to the bottom panel;
allowing bees to lay eggs within the channels;
releasing the coupled top panel from the bottom panel;
while connected by the hinge connection, pivoting the top panel relative to the bottom panel to expose the channels; and
harvesting the eggs from the nesting block.

13. The method of claim 12, wherein the channels have a circular cross-section.

14. The method of claim 12, further comprising the step of placing the nesting block in a nesting block holder.

15. The method of claim 12, wherein the step of forming a sealing engagement comprises engaging a tongue and groove engagement.

16. The method of claim 12, wherein:
the hinge connection comprises a shaft and a resilient receiver configured to receive the shaft; and
the step of connecting adjacent panels by a hinge connection comprises applying pressure to the shaft and the resilient receiver such that the shaft is received by the resilient receiver.

17. The method of claim 12, further comprising the step of aligning adjacent panels with an alignment pin on the panels.

18. The method of claim 12, wherein:
the coupling is a resilient clip and a clip receiver; and
the step of coupling adjacent panels comprises coupling the resilient clip to the clip receiver.

19. The method of claim 12, wherein the step of stacking panels comprises stacking a plurality of intermediate panels on a base panel and staking a capping panel on the plurality of intermediate panels.

20. The method of claim 12, wherein the number of intermediate panels is adjustable.
